(19) United States
(12) Patent Application Publication
(10) Pub. No.: US 2011/0047053 A1
(43) Pub. Date: Feb. 24, 2011

(54) METHOD AND SMART CARD FOR PROVIDING LOCATION BASED SERVICE

(75) Inventors: Youngmin Kim, Gyeonggi-Do (KR); Jinwook Chong, Gyeonggi-Do (KR); Sungjae Byun, Gyeonggi-Do (KR)

Correspondence Address: David A. Einhorn, Esq.;Baker & Hostetler LLP, 45 Rockefeller Plaza, New York, NY, 10111, US

(73) Assignee: SK TELECOM CO., LTD., Seoul (KR)

(21) Appl. No.: 12/922,952

(22) PCT Filed: Feb. 26, 2009
(86) PCT No.: PCT/KR2009/000922

§ 371 Date: Sep. 16, 2010

(30) Foreign Application Priority Data
Mar. 17, 2008 (KR) 10-2008-0024518

(51) Int. Cl. G01C 21/00; G06Q 40/00

(52) U.S. Cl. 705/30; 701/208

(57) ABSTRACT

A method and a smart card for providing location based services are provided. The smart card connectable to a mobile terminal has a card-dedicated GPS module for receiving radio signals from one or more satellites to extract navigation data contained in the radio signals; a card-dedicated communication module for transceiving data related to the location-based services (LBS) in an interworking relationship with the mobile terminal; a card-dedicated storage module for storing map data related to the location based services and indoor map data; a card-dedicated indoor module for providing the LBS using the indoor map data; and a card-dedicated LBS platform for providing the LBS through extracting a current location of the mobile terminal using the navigation data and controlling the card-dedicated indoor module to be switched into an active state if the card-dedicated GPS module fails to receive the radio signals from the satellite.

### FIELD

The present disclosure relates to a method and a smart card for providing location based services. More particularly, the present invention relates to a method and a smart card device for providing location-based services to mobile communication terminals wherein the smart card has a stored value card or simply card-dedicated GPS module, a card-dedicated LBS platform, and map data for connection with even a non-GPS model of the terminals to provide accurate location-based services in a profitable structure to generate a revenue pool for mobile network operators, application providers, and LBS technology vendors.

### BACKGROUND

The statements in this section merely provide background information related to the present disclosure and may not constitute prior art.

Following advancements of computers, electronics, and communication technology breakthroughs introduced a variety of telecommunication services through wireless networks. Accordingly, the wireless networks using the mobile communication system provide the services from voice callings to such multimedia communication services as transmitting data including circuit data and packet data. Recently, the LBS market is recognized as emerging with the release of GPS phones, but a reliable locating accuracy is still lacking and a large network investment involved stalls the market vitalization.

Therefore, despite the increased need for the LBS solutions thanks to its reliable location information to complement even the GPS deficiency in the shaded areas with its attractively low investment, the main disadvantage was that the frequency leasing mobile network operators (MNO) had hardships to offer their desired LBS or value-added services on their targeted schedules without the mobile terminal manufacturers' active supports such as an interworking design with the terminal platform.

In particular, the MNO encounters many restrictions including the matter of supporting the non-GPS terminals for the LBS function and the terminal manufacturers' own embedding of the LBS function before the MNO is able to offer the proper time-to-market LBS.

In view of the above problems, the present disclosure seeks to provide portable location-based services to mobile terminals in a method of connecting a smart card having a card-dedicated GPS module, a card-dedicated LBS-platform, and map data so that even non-GPS model mobile terminals can carry accurate location-based services in order to build a revenue pool for the MNO, application providers, and LBS technology vendors.

### SUMMARY

To achieve the above objects, one embodiment provides a smart card comprising: a card-dedicated global positioning system (GPS) module for receiving radio signals from one or more satellites to extract navigation data contained in the radio signals; a card-dedicated communication module for transceiving data related to the location-based services (LBS) in an interworking relationship with the mobile terminal; a card-dedicated storage module for storing map data related to the LBS and indoor map data; a card-dedicated indoor module for providing the LBS using the indoor map data; and a card-dedicated LBS platform for providing the LBS through extracting a current location of the terminal using the navigation data and controlling the card-dedicated indoor module to be switched into an active state if the card-dedicated GPS module fails to receive the radio signals from the satellite.

Another embodiment provides a method for providing location-based services with a smart card connected to mobile communication terminals comprising: receiving radio signals from one or more satellites using a mounted card-dedicated global positioning system (GPS) module; extracting navigation data contained in the radio signals using the card GPS module; extracting the current location information of the mobile terminal from the navigation data using a card-dedicated LBS (specific location based service) platform; and outputting the current location information to a prestored map data using the card LBS platform.

According to the disclosure, by connecting the smart card having the card GPS module, card LBS platform, and map data to a mobile terminal even without GPS an accurate LBS may be offered to allow the generated profits to be systemically shared among the MNO, application providers, and LBS technology vendors.

In addition, the present disclosure promotes the average revenue per user (ARPU) of the frequency leasing MNO. Also increased for the MNO are the sales from the advertising revenue and traffic fees as a result.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram illustrating a system including a mobile terminal and a smart card for providing location based services according to an embodiment;

FIG. 2 is a schematic block diagram illustrating the system of FIG. 1 according to an embodiment;

FIG. 3 is a flow chart for explaining a method for providing the location based services according to an embodiment; and

FIG. 4 is a block diagram for illustrating the method for providing the location based services according to an embodiment.

### DETAILED DESCRIPTION

Hereinafter, an exemplary embodiment of the present disclosure will be described with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

Also, in describing the components of the present disclosure, there may be terms used like the first, second, A, B, (a), and (b). These are solely for the purpose of differentiating one component from the other but not to imply or suggest the substances, order or sequence of the components. If a component were described as ‘connected’, ‘coupled’, or ‘linked’ to another component, it may mean the components are not only directly ‘connected’, ‘coupled’, or ‘linked’ but also are indirectly ‘connected’, ‘coupled’, or ‘linked’ via a third component.

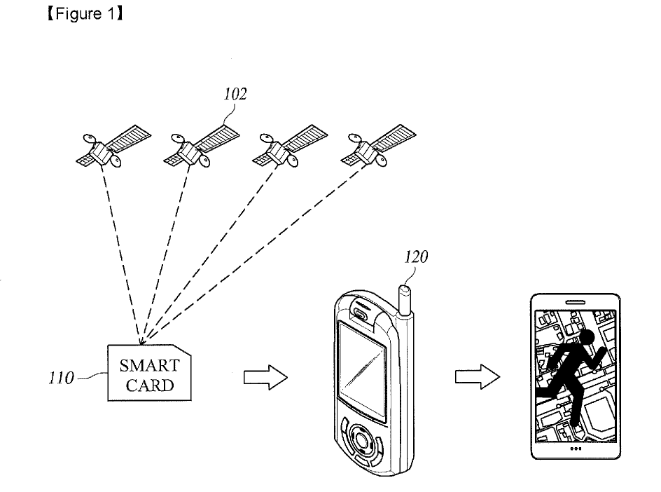

FIG. 1 is a schematic diagram illustrating a system including a smart card 110 for providing location based services and a mobile terminal 120 according to an embodiment of the present disclosure.

The present LBS system with the smart card and the terminal may also include satellites 102. The satellites 102 may comprise at least one or more artificial satellites and operates to transmit radio signals including navigation data.

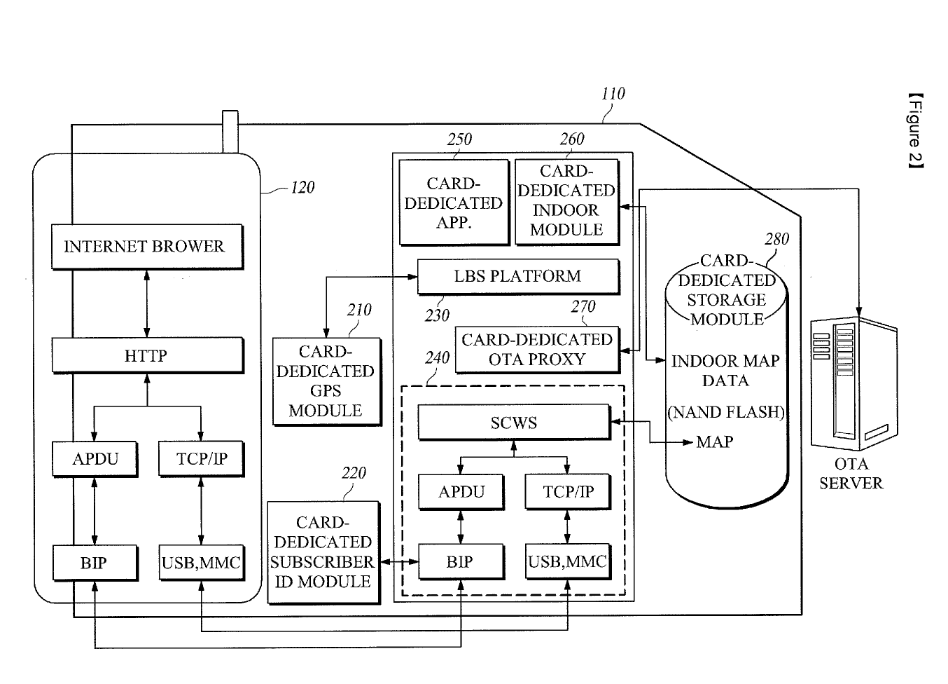

Referring to FIG. 2, the smart card 110 may generally have a card-dedicated GPS module 210 capable of providing location-based services, a card-dedicated subscriber identification module 220, a card-dedicated LBS platform 230, a card-dedicated communication module 240, and a card-dedicated storage module 280 so that it connects to the terminal 102 for the purpose of the location-based services. The smart card 110 will be detailed below.

The terminal 120 may mean a device equipped with an external memory slot (not shown) to which the smart card 110 is connected and the terminal 120 may interwork with a mobile communication network to carry out typical voice callings and data communications wirelessly. The terminal 120 may be a PDA (personal digital assistant), cellular phone, PCS (personal communication service) phone, hand-held PC, CDMA-2000 phone, WCDMA phone, PMP (portable multimedia player), PSP (Play Station Portable), or MBS (mobile broadband system).

FIG. 2 schematically shows the mobile terminal and the smart card for providing the location-based services according to an embodiment.

The terminal 120 may incorporate a wireless Internet browser, HTTP (hypertext transfer protocol), APDU (application protocol data unit), TCP/IP (transmission control protocol/Internet protocol), BIP (bearer independent protocol), USB (universal serial bus), and MMC (multimedia card).

In addition to the card-dedicated GPS module 210, card-dedicated subscriber ID module 220, card-dedicated LBS platform 230, card-dedicated communication module 240, and card-dedicated storage module 280, the smart card 110 includes a card-dedicated app 250, a card-dedicated indoor module 260, and a card-dedicated OTA (over the air) proxy 270.

The card-dedicated GPS module 210 may be conceptualized as a means to receive radio signals from one or more satellites and encompass a GPS antenna capable of extracting navigation data included in the radio signals, a GPS receiver, and a GPS chipset, although it is so termed for the purpose of this disclosure of its implementation inside the smart card.

In addition, as a candidate for the card-dedicated GPS module 210 a type of module may be used having an internal MSM™ (Mobile Station Modem) chip with a Qualcomm of USA's GPS One™ algorithm installed.

The card-dedicated subscriber ID module 220 that may be in the form of a card adapted to use with the mobile terminal 120 is, for example, a chip with a storage for personal information to help serve subscriber's authentication, billing, security functions, although it is so termed for the purpose of this disclosure of its implementation inside the smart card.

For the card-dedicated subscriber ID module 220, SIM (subscriber identity module) or USIM (universal subscriber identity module) may be used.

Although the present disclosure recites that the smart card includes the card-dedicated subscriber ID module 220 for a mere illustrative purpose, a person skilled in the art can have the card-dedicated subscriber ID module 220 changed or modified in various ways to be excluded from the smart card 110.

Although the name is to signify its implementation inside the smart card 110, the card-dedicated LBS platform 230 means a hierarchical system comprised of computer system's fundamental hardware and software components wherein the computer comprises the lowest level section of the IC chips or similar hardware and the next higher level section including firmware, an operation system, and application programs.

Also, interworking with the card-dedicated GPS module 210, the card-dedicated LBS platform 230 may function to receive the navigation data of the radio signals for use in extracting and providing the current location of the mobile terminal 120.

Further, the card-dedicated LBS platform 230 may function to check whether the card-dedicated GPS module 210 receives radio signals from the satellites, and upon confirming that the card-dedicated GPS module 210 fails to receive them, it determines the mobile terminal 120 as entered the shadow area and switches the card-dedicated indoor module 260 into an active state.

The card-dedicated communication module 240 may include SCWS (smart card web server), APDU (application protocol data unit), TCP/IP (transmission control protocol/Internet protocol), BIP (bearer independent protocol), USB (universal serial bus), and MMC (multimedia card) and serves as a communication means to have the smart card 110 interwork with an external web server as well as the mobile terminal 120, although it is conveniently termed for the purpose of this disclosure of its implementation inside the smart card.

The SCWS is to interwork with the external web server, and the APDU means the data format in which an entity interested in the data transmission may communicate with the smart card 110.

TCP/IP means the basic communication protocol of the Internet while BIP is the protocol for transmission of data.

USB denotes the bus standard of connecting a PC and peripheral devices, and MMC stands for an external memory supported by the mobile terminal 120.

The card-dedicated app 250 means various applications that can be included in the smart card 110.

The card-dedicated indoor module 260 functions to receive the location information parameters for the mobile terminal 120 from the mobile communication network and then analyze the same to extract information of the current location of the terminal 120, and to control outputting the current location information onto the indoor map data, and it is conveniently termed for the purpose of this disclosure of its implementation inside the smart card.

In the actual implementation of the present disclosure, a pCell module may be used for the card-dedicated indoor module 260. Here, the pCell module means a global positioning service to construct a pCELL database having the area subjected to the positioning service dissected into predetermined grid cells, constantly determine whether a positioning request was issued from a service subscriber, and at such request compare received basic information from the mobile terminal 120 with the pCELL database to determine matching pCELLs before informing the same to the service requester.

Although the present disclosure exemplifies the card-dedicated indoor module 260 as incorporated into the smart card 110 just to facilitate understanding of the technical idea of the disclosure, to have the card-dedicated indoor module 260 changed and modified into an external member would readily occur to a person skilled in the art without departing from the essential characteristics of the present disclosure.

The card-dedicated OTA proxy 270 is a kind of module that functions to relay signals in a wireless communication system by a standard of transceiving information on a system registration, and it is so termed for the purpose of this disclosure of its implementation inside the smart card.

The card-dedicated storage module 280 is a module for storing data in the smart card 110, and it is so termed for the purpose of this disclosure of its implementation inside the smart card. Also, the card-dedicated storage module 280 may be preferably formed of a NAND flash memory and function to store information including the indoor map data and map data related to the location-based services.

In addition, the smart card 110 of an embodiment of the present disclosure may further comprise a card-dedicated profit sharing module to allow one or more of the application providers, MNO, and LBS technology vendors to share the generated profits between them.

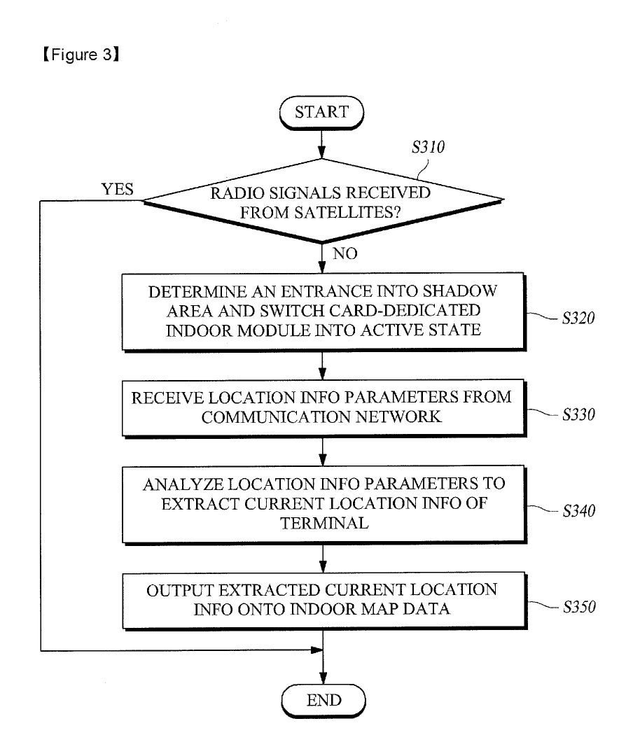

FIG. 3 is a flow chart for explaining a method for providing the location based services according to an embodiment.

The card-dedicated LBS platform 230 uses the card-dedicated GPS module 210 to check whether the radio signals are received from the satellites in step S310. If the answer to step S310 is negative with no satellite signal reception, it determines the smart card 110 as entered the shadow area and switches the card-dedicated indoor module 260 into an active state in step S320.

For example, in case the smart card 110 entering a particular building or bad weather condition disabling such signal reception from the satellite 102, the card-dedicated LBS platform 230 switches the card-dedicated indoor module 260 from an inactive to an active state.

Of course, when the radio signal reception is reinstated from the satellite, the card-dedicated LBS platform 230 may switch the card-dedicated indoor module 260 back to the inactive state and then use the extracted navigation data from the received radio signals.

The card-dedicated indoor module 260 receives the location information parameters for the mobile terminal 120 from the mobile communication network (not shown) in step S330. Specifically, if the smart card 110 determines its entrance into the shadow area, the card-dedicated indoor module 260 receives from the mobile communication network the location information parameters including base station information for the mobile terminal 120, its PN value, Rx, Tx, and Ec/Io.

Next in step S340, the card-dedicated indoor module 260 analyzes the received location information parameters to extract information of the current location of the mobile terminal 120.

For example, an analysis of PN value included in the location information parameter will tell the location of the base station, and the current location information of the terminal 120 may be extracted by approximating its distance of several meters from the vicinity of the corresponding base station using the signal delay involved. The card-dedicated indoor module 260 outputs the extracted current location information onto the indoor map data in step S350.

For example, the mobile terminal 120 may extract from an indoor map database the corresponding location to the current location information and output the same information toward the corresponding location.

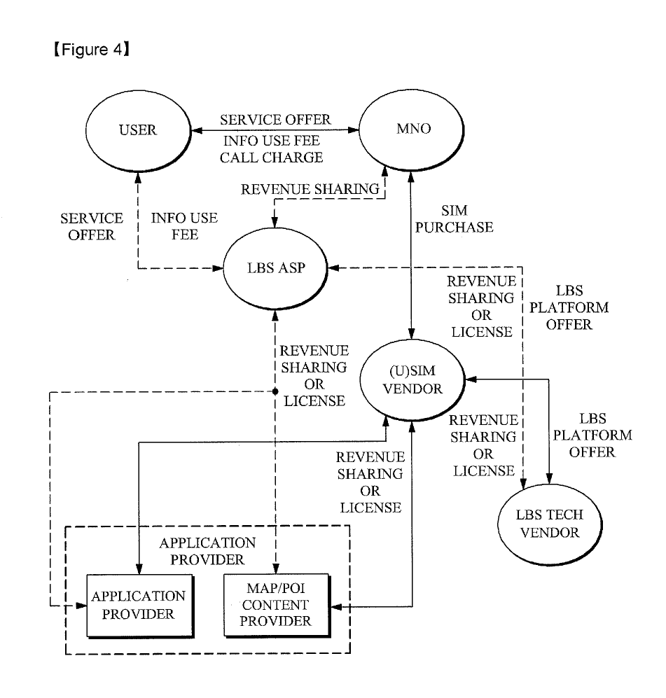

FIG. 4 is a block diagram for illustrating the method for providing the location based services according to an embodiment. As depicted in the drawing, it has been systemized to offer the location based services to the users with the generated revenue shared among the frequency leasing MNO, (U)SIM vendors, LBS technology vendors, and application providers.

Although the LBS market is recognized as emerging along with new GPS terminals introduced, the reliability issues on the GPS terminals and the enormous investment on the necessary network infrastructure have critically slowed down its vitalization subjected to the revenue structure shown in solid lines of FIG. 4.

Therefore, in the current providing system for extra services like the LBS to date, users were offered the LBS by the MNO which has purchased the SIM from the (U)SIM vendor which is supposed to share the revenue with the application providers and the LBS technology vendors, and so it was difficult for the MNO to serve the market with their desired form of the LBS on their targeted schedule without the mobile terminal manufactures' active supports including loading applications and contents and interworking designs with the terminal platform.

In particular, the MNO encounters many restrictions from the matters of supporting the non-GPS terminals for the LBS function and the terminal manufacturers' own embedding of the LBS function before the MNO is able to offer the proper time-to-market LBS.

The method for providing the location based services according to an embodiment as shown in FIG. 3 permits a simple connection of the mobile terminal 120 and smart card 110 to operate an LBS application server process (LBS ASP) resulting in a shift of the revenue sharing scheme that comes among the LBS ASP, MNOs, LBS technology vendors, and application providers. I.e., the implementation of the GPS module inside the smart card 110 achieves the improved revenue structure shown in dotted lines of FIG. 4.

Moreover, for example, a certain company identifiable by N is reportedly trying to override the MNO industry by equipping their mobile phone products with GPS to inroad into the established market which threatens the MNOs through intensifying the MNOs' dependency on the big phone manufacture's products and inevitably eroding the entitled turf of the smaller companies but such an uncontrollable manner of business may be regulated through the revenue sharing scheme in the dotted lines of FIG. 4.

Meanwhile, notwithstanding the high demand of an accuracy enhanced LBS solution, various MNOs worldwide have had negative opinions against the server solution to location based services opposing the obstacles including the initial investment, the difficult task of changing the network itself, the maintenance and repair jobs to follow, and the long installation time. However, according to the embodiment of the present disclosure as depicted by the dotted lines in FIG. 4, the user will be provided with the LBS from the LBS ASP, which uses the revenue sharing structure among the MNOs, application providers, LBS technology vendors for allowing the MNOs to be clear of the above noted obstacles and fulfill the LBS through a high performance SIM card processor development, a card manufacture, and a platform establishment to install the GPS and indoor solutions, LBS applications, and map contents.

Although exemplary embodiments of the present disclosure have been described for illustrative purposes, those skilled in the art will appreciate that various modifications, additions and substitutions are possible, without departing from essential characteristics of the disclosure. Therefore, exemplary embodiments of the present disclosure have not been described for limiting purposes. Accordingly, the scope of the disclosure is not to be limited by the above embodiments but by the claims and the equivalents thereof.

### INDUSTRIAL APPLICABILITY

As described above, the present disclosure is useful in a method and a smart card for providing location based services wherein the smart card equipped with the card-dedicated GPS module, card-dedicated LBS platform, and map data is adapted to be coupled to the mobile terminal that may be a non-GPS device, which then can offer the accurate location based services and the generated revenue to be distributed in a share structure among the mobile network operators, application providers, and LBS technology vendors, thereby causing a substantial enhancement of the average revenue per user or ARPU for the frequency leasing MNOs.

### CROSS-REFERENCE TO RELATED APPLICATION

If applicable, this application claims a priority under 35 U.S.C §119(a) on Patent Application No. 10-2008-0007666 filed in Korea on Jan. 24, 2008, the entire content of which is hereby incorporated by reference. In addition, this non-provisional application claims the priority in countries, other than U.S., with the same reason based on the Korean Patent Application, the entire content of which is hereby incorporated by reference.

What is claimed is:

1. A smart card connectable to a mobile terminal comprising:
a card-dedicated global positioning system (GPS) module for receiving radio signals from one or more satellites to extract navigation data contained in the radio signals;
a card-dedicated communication module for transceiving data related to the location-based services (LBS) in an interworking relationship with the mobile terminal;
a card-dedicated storage module for storing map data related to the location based services and indoor map data;
a card-dedicated indoor module for providing the location based services using the indoor map data; and
a card-dedicated LBS platform for providing the location based services through extracting a current location of the mobile terminal using the navigation data and controlling the card-dedicated indoor module to be switched into an active state if the card-dedicated GPS module fails to receive the radio signals from the satellite.

2. The smart card for providing LBS of claim 1, further comprising a card-dedicated subscriber identification module, which stores information of a subscriber to the mobile terminal.

3. The smart card for providing LBS of claim 2, wherein the card-dedicated subscriber identification module is a subscriber identity module (SIM) or a universal subscriber identity module (USIM).

4. The smart card for providing LBS of claim 1, wherein the card-dedicated communication module comprises a smart card web server (SCWS), an application protocol data unit (APDU), a transmission control protocol/Internet protocol (TCP/IP), a bearer independent protocol (BIP), a universal serial bus (USB), and a multimedia card (MMC).

5. The smart card for providing LBS of claim 1, wherein the card-dedicated indoor module receives and analyzes location information parameters for the mobile terminal from a mobile communication network to extract the information of the current location of the mobile terminal, and to control outputting the current location information onto the indoor map data.

6. The smart card for providing LBS of claim 1, further comprising a card-dedicated over the air (OTA) proxy that relays signals in a wireless communication system by a standard of transceiving information on a system registration while using the OTA proxy to interwork with an OTA server.

7. The smart card for providing LBS of claim 1, wherein the card-dedicated storage module comprises a NAND flash memory.

8. The smart card for providing LBS of claim 1, further comprising a card-dedicated revenue sharing module for calculating information use fees for the location based services to share the fee revenue with at least one of application providers, mobile network operators, and LBS technology vendors.

9. A method for providing location-based services with a smart card connectable to a mobile communication terminal comprising:
receiving radio signals from one or more satellites using a mounted card-dedicated global positioning system (GPS) module;
extracting navigation data contained in the radio signals using the card-dedicated GPS module;
extracting current location information of the mobile terminal with reference to the navigation data using a mounted card-dedicated location based service (LBS) platform; and
outputting the current location information to a prestored map data using the card-dedicated LBS platform.

10. The method for providing location-based services of claim 9, further comprising after outputting the current location information:
at no reception of the radio signals from the satellite, switching a card-dedicated indoor module into an active state using the card-dedicated LBS platform;
receiving location information parameters from a mobile communication network using the card-dedicated indoor module;
extracting the current location information through analyzing the location information parameters using the card-dedicated indoor module; and
outputting the current location information onto in indoor map data using the card-dedicated indoor module.
